(19) United States
(12) Patent Application Publication
(10) Pub. No.: US 2012/0099664 A1
(43) Pub. Date: Apr. 26, 2012

(54) METHOD OF MULTIPLE FRAME TRANSMISSION IN WIRELESS COMMUNICATION SYSTEM AND TRANSMITTER

(75) Inventors: Min Ho CHEONG, Daejeon (KR); Sok Kyu Lee, Daejeon (KR)

(73) Assignee: Electronics and Telecommunications Research Institute, Daejeon (KR)

(21) Appl. No.: 13/282,119

(22) Filed: Oct. 26, 2011

(30) Foreign Application Priority Data
Oct. 26, 2010 (KR) 10-2010-0104958
Oct. 26, 2011 (KR) 10-2011-0109878

(51) Int. Cl. H04L 27/00

(52) U.S. Cl. 375/259

(57) ABSTRACT

A method for multiple frame transmission in a wireless communication system and a transmitter are provided. The transmitter transmits a request to send (RTS) frame to a receiver. The RTS frame has a first bandwidth. The transmitter receives a clear to send (CTS) frame as a response of the RTS frame from the receiver to establish a transmission opportunity (TXOP) indicating an interval of time when the transmitter has the right to transmit at least one data frame. The CTS frame has a second bandwidth. The transmitter transmits a plurality of data frames sequentially to the receiver during the TXOP.

### CROSS-REFERENCE TO RELATED APPLICATIONS

This application claims the benefit of priority of Korean Patent Application Nos. 10-2010-0104958 filed on Oct. 26, 2010 and 10-2011-0109878 filed on Oct. 26, 2011, all of which are incorporated by reference in its entirety herein.

### BACKGROUND OF THE INVENTION

1. Field of the Invention

The present invention relates to wireless communication, and more particularly, to a method for multiple frame transmission in a wireless communication system, and a transmitter using the same.

2. Related Art

Recently, various wireless communication technologies are under development in line with the advancement of information communication technology. Among them, a wireless local area network (WLAN) is a technique allowing mobile terminals such as personal digital assistants (PDAs), lap top computers, portable multimedia players (PMPs), and the like, to wirelessly access the Internet at homes, in offices, or in a particular service providing area, based on a radio frequency technology.

The IEEE 802.11n is a technical standard relatively recently introduced to overcome a limited data rate which has been considered as a drawback in the WLAN. The IEEE 802.11n is devised to increase network speed and reliability and to extend an operational distance of a wireless network. More specifically, the IEEE 802.11n supports a high throughput (HT), i.e., a data processing rate of up to above 540 Mbps, and is based on a multiple input and multiple output (MIMO) technique which uses multiple antennas in both a transmitter and a receiver to minimize a transmission error and to optimize a data rate. This specification uses a coding scheme which transmits a copy of data one or more times to improve a reliability of data and also uses Orthogonal Frequency Division Multiplexing (OFDM) to improve a data rate.

A basic access mechanism of an Institute of Electrical and Electronics Engineers (IEEE) 802.11 Medium Access Control (MAC) is a Carrier Sense Multiple Access with Collision Avoidance (CSMA/CA) combined with binary exponential backoff. The CSMA/CA mechanism is also called a Distributed Coordination Function (DCF) of IEEE 802.11 MAC, basically employing a “listen before talk” access mechanism. In this type of access mechanism, a station (STA) first listens to a radio channel or a medium before starting a transmission. Upon listening, when it is detected that the medium is not is use, the listening station starts its transmission. Meanwhile, when it is detected that the medium is in use, the station enters a delay period determined by a binary exponential backoff algorithm, rather than starting its transmission.

The CSMA/CA mechanism includes virtual carrier sensing as well as physical carrier sensing in which the STA directly listens to a medium. The virtual carrier sensing is to complement the limitation of the physical carrier sensing such as a hidden node problem, or the like. For the virtual carrier sensing, IEEE 802.11 MAC uses a Network Allocation Vector (NAV). The NAV is a value for the STA, which currently uses the medium or has authority to use the medium, to indicate a time remaining for the medium to be available, to other STAs. Thus, the value set as the NAV corresponds to a period during which the medium is due to be used by the STA which transmits a corresponding frame.

One of procedures for setting the NAV is a procedure of exchanging a Request To Send (RTS) frame and a Clear To Send (CTS) frame. The RTS frame and the CTS frame include information informing reception STAs about an upcoming frame transmission to delay a frame transmission by the reception STAs. The information may be included in a duration field of each of the RTS frame and the CTS frame. When the RTS frame and the CTS frame are exchanged, a source STA transmits an actual frame desired to be transmitted to a target STA.

A Transmission Opportunity (TXOP) is opposite to the NAV which prevents transmission of data frame. The TXOP is an interval of time when the STA has the right to transmit at least one data frame.

An existing IEEE 802.11 system supports a bandwidth of 20 MHz or 40 MHz. However, in order to obtain a higher throughput, it is required to support a bandwidth of 80 MHz or more.

An existing CSMA/CA system is based on the assumption that when the NAV or the TXOP is established, an established bandwidth is not changed. However, the entirety of the established band may be not always used in the TXOP established as a broadband.

For example, in accordance with the introduction of multi-user MIMO (MU-MIMO), data on a plurality of STAs may be transmitted as a single aggregated MAC protocol data unit (A-MPDU). The number of STAs is reduced within the established TXOP, such that a size of the A-MPDU may be reduced. Therefore, a required bandwidth may be reduced.

A need exists for a method of dynamically allocating and adjusting a bandwidth.

### SUMMARY OF THE INVENTION

The present invention provides a method for multiple frame transmission capable of dynamically adjusting a bandwidth.

The present invention also provides a transmitter capable of dynamically adjusting a bandwidth.

In an aspect, a method for multiple frame transmission in a wireless communication system includes transmitting, by a transmitter, a request to send (RTS) frame to a receiver, the RTS frame having a first bandwidth, receiving, by the transmitter, a clear to send (CTS) frame as a response of the RTS frame from the receiver, thereby establishing a transmission opportunity (TXOP) indicating an interval of time when the transmitter has the right to transmit at least one data frame, the CTS frame having a second bandwidth, and transmitting, by the transmitter, a plurality of data frames sequentially to the receiver during the TXOP, wherein a bandwidth of each data frame is equal to or less than the second bandwidth, and wherein a bandwidth of a subsequent data frame is equal to or less than a bandwidth of a preceding data frame which is last previously transmitted before the subsequent data frame.

The second bandwidth may be equal to or less than the first bandwidth.

The first bandwidth may be one of 40 MHz, 80 MHz and 160 MHz and the second bandwidth may be one of 20 MHz, 40 MHz, 80 MHz and 160 MHz.

The RTS frame may duplicately be transmitted over each 20 MHz of the first bandwidth.

The CTS frame may duplicately be received over each 20 MHz of the second bandwidth.

In another aspect, a transmitter of multiple frame transmission in a wireless communication system comprising a processor configured to transmit a request to send (RTS) frame to a receiver, the RTS frame having a first bandwidth, receive a clear to send (CTS) frame over a second bandwidth as a response of the RTS frame from the receiver, thereby establishing a transmission opportunity (TXOP) indicating an interval of time when the transmitter has the right to transmit at least one data frame, the CTS frame having a second bandwidth, and transmit a plurality of data frames sequentially to the receiver during the TXOP, wherein a bandwidth of each data frame is equal to or less than the second bandwidth, and wherein a bandwidth of a subsequent data frame is equal to or less than a bandwidth of a preceding data frame which is last previously transmitted before the subsequent data frame.

A bandwidth may be dynamically adjusted in a RTS-CTS process. In addition, a bandwidth of a data frame may be adjusted during a TXOP, such that other STAs may utilize idle sub-channels.

### BRIEF DESCRIPTION OF THE DRAWINGS

FIG. 1 illustrates the configuration of a wireless local area network (WLAN) system according to an exemplary embodiment of the present invention.

FIG. 2 illustrates a method for multiple frame transmission according to the exemplary embodiment of the present invention.

FIG. 3 is a flow chart illustrating a method for multiple frame transmission according to the exemplary embodiment of the present invention.

FIG. 4 is a flow chart illustrating a method for bandwidth information transmission in a sounding procedure.

FIG. 5 is a block diagram illustrating a transmitter in which the exemplary embodiment of the present invention is implemented.

### DESCRIPTION OF EXEMPLARY EMBODIMENTS

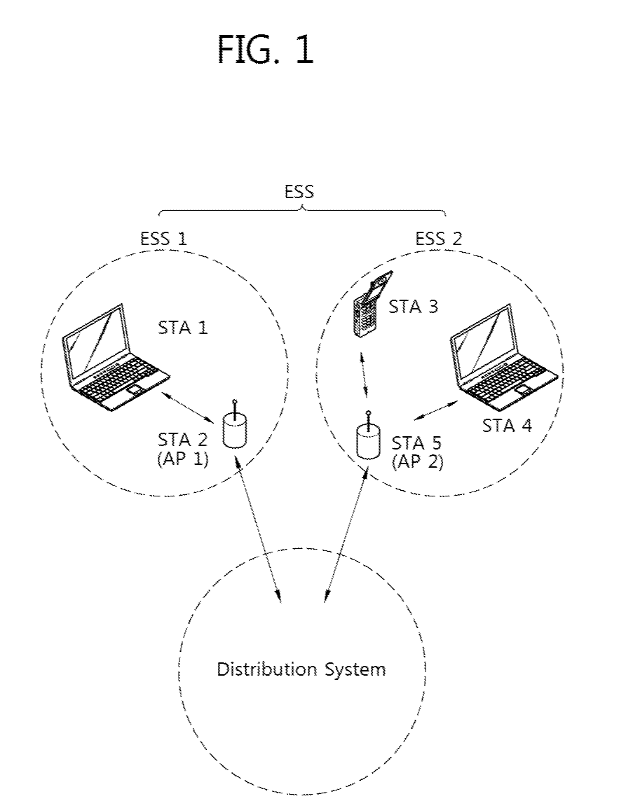

FIG. 1 illustrates the configuration of a wireless local area network (WLAN) system according to an exemplary embodiment of the present invention.

A WLAN system includes one or more of basic service sets (BSSs). A BSS refers to a set of stations (STAs) that can communicate with each other in synchronization, rather than a concept indicating a particular area. A BSS that supports data processing at a high speed of 1 GHz or faster is called a VHT BSS.

A VHT system including one or more VHT BSSs may use a channel band width of 80 MHz, but it is merely illustrative. For example, the VHT system may use a channel bandwidth of 20 MHz, 40 MHz, 80 MHz, 160 MHz, or larger. The VHT system has a multi-channel environment including a plurality of subchannels each having a channel bandwidth of a certain size, e.g., a channel bandwidth of 20 MHz.

Subchannels may be classified into a primary channel and a secondary channel. One of subchannels may be designated as the primary channel. The a secondary channel is a non-primary channel.

The BSS may be divided into an infrastructure BSS and an independent BSS (IBSS). FIG. 1 illustrates the infrastructure BSS. The infrastructure BSS (BSS1 and BSS2) includes one or more stations (STAs) (STA1, STA3, STA4), an access point (AP) as a station (STA) providing a distribution service, and a distribution system connecting a plurality of APs (AP1 and AP2). Meanwhile, the IBSS, not including an AP, includes every station (STA) as a mobile station. The IBSS establishes a self-contained network, not allowing an access to a distribution system (DS).

A STA is a certain function medium including a medium access control (MAC) following the stipulation of IEEE 802.11 standard and a physical layer interface with respect to a wireless medium. A station includes both AP and non-AP stations in a broad sense. A station supporting high speed data processing of 1 GHz or faster in a multi-channel environment (to be described) is called a VHT station.

A STA for radio communications may include a processor and a radio frequency (RF) unit, and may further include a user interface, a display unit, and the like. The processor, a function unit configured to generate a frame to be transmitted via a wireless network or process a frame received via the wireless network, performs various functions to control a station. The RF unit, which is functionally connected with the processor, is configured to transmit and receive frames via the wireless network for the station.

Among the stations STAs, a mobile terminal manipulated by a user is a non-AP STA (STA1, STA3, STA4), and simply referring to a station may indicate a non-AP STA. The non-AP STA may be referred to by other names such as terminal, wireless transmit/receive unit (WTRU), user equipment (UE), mobile station (MS), mobile terminal, mobile subscriber unit, or the like. A non-AP STA supporting high speed data processing at 1 GHz or faster in a multi-channel environment (to be described) is called a non-AP VHT STA.

The APs (AP1 and AP2) are functional entities for providing an access to the DS by way of a wireless medium for an STA (Associated Station) associated thereto. In the infrastructure BSS including the APs, in principle, communications between non-AP STAs are made by way of the APs, but when a direct link has been established, the non-AP STAs can directly communicate with each other. The AP may be also called by other names such as centralized controller, base station (BS), node-B, base transceiver system (BTS), site controller, and the like. In the multi-channel environment, an AP supporting high speed data processing at 1 GHz or faster is called a VHT AP.

A plurality of infrastructure BSSs may be connected via the DS. The plurality of BSSs connected via the DS is called an extended service set (ESS). STAs included in the ESS may communicate with each other, and a non-AP STA may move from one BSS to another BSS within the same ESS while seamlessly performing communication.

The DS is a mechanism allowing one AP to communicate with another AP. Through the DS, an AP may transmit a frame for STAs associated to the BSS managed by the AP, transfer a frame when one STA moves to another BSS, or transmit or receive frames to and from an external network such as a wired network.

The DS may not be necessarily a network. Namely, the DS is not limited to any form so long as it can provide a certain distribution service stipulated in IEEE 802.11 standard. For example, the DS may be a wireless network such as a mesh network or a physical structure connecting the APs.

Although a WLAN system using a multi-channel including four contiguous subchannels having a channel bandwidth of 20 MHz is assumed in exemplary embodiments to be described below, it is only an example. The number of subchannel or the channel bandwidth thereof is not limited. For example, the bandwidth of the subchannel may be 5 MHz, 10 MHz, 40 MHz, or 80 MHz. A multi-channel may include non-contiguous channels. For example, 80+80 MHz means that a multi-channel is configured of two non-contiguous channels having a bandwidth of 80 MHz.

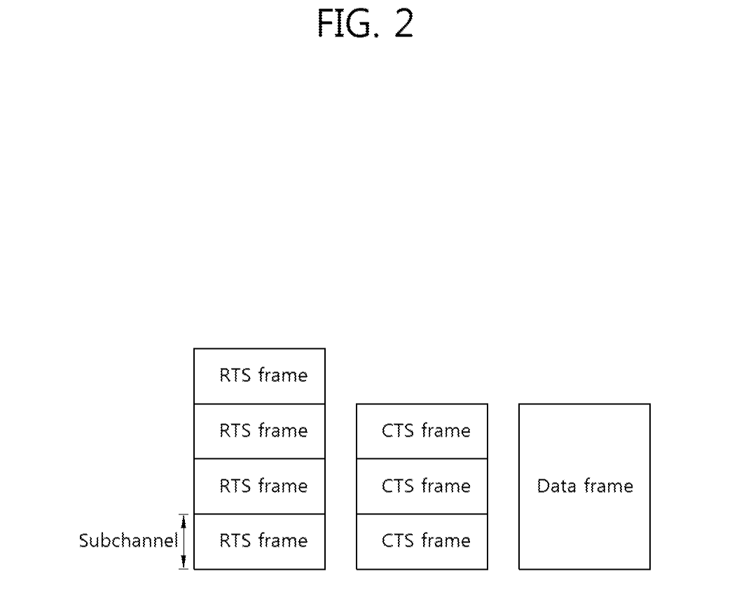

FIG. 2 illustrates a method for multiple frame transmission according to the exemplary embodiment of the present invention.

A RTS frame and a CTS frame are transmitted in a subchannel unit. When a subchannel has a bandwidth of 20 MHz, four RTS frames are duplicately transmitted over a bandwidth of 80 MHz. Likewise, three CTS frames may be duplicately transmitted over a bandwidth of 60 MHz.

The transmission of the frames in the subchannel unit as described above may allow a transmitter to more easily negotiate an available bandwidth when a plurality of subchannels are present. For example, when it is assumed that the entire bandwidth of 160 MHz is available but a bandwidth of an idle channel is 80 MHz, the transmitter transmits the RTS frames over the bandwidth of the idle channel of 80 MHz. Then, a receiver receiving the RTS frame transmits the CTS frames over the bandwidth of the idle channel of 60 MHz. The transmitter transmits a data frame over the bandwidth of 60 MHz over which the CTS frame is received.

The data frame may be transmitted using SU-MIMO or MU-MIMO.

The subchannels used by the RTS frame, the CTS frame, and the data frame may be contiguous.

The data frame is transmitted over a bandwidth equal to or less than a bandwidth of the CTS frame. A plurality of data frames may be transmitted. A band width of a subsequent data frame may be equal to or less than a bandwidth of a preceding data frame.

The bandwidth of the subsequent data frame may be less than the bandwidth of the preceding data frame, but may not be larger than the bandwidth of the preceding data frame. This has an advantage in that a bandwidth that is not used may be allocated to other STAs. That is, assume that a first data frame is transmitted over a bandwidth of 60 MHz and a subsequent data frame is transmitted over a bandwidth of 40 MHz. At this time, other STAs may determine that a subchannel that is not used is idle to initiate a RTS-CTS process. The subchannels over which the data frame is transmitted may be contiguous.

A RTS frame may include a transmitter address field indicating an address of a transmitter transmitting the RTS frame, a receiver field indicating an address of a receiver, and a duration field. The duration field indicates a time required to transmit a pending data frame, a CTS frame, an acknowledge (ACK) frame, and a plurality of short interframe space (SIFS) interval.

The CTS frame includes an address field indicating a transmitter indicated by the transmitter address field of the RTS frame and a duration field. The duration field indicates a time in which the CTS frame and the SIFS intervals are excluded from a value obtained from the duration field of the RTS frame.

The RTS frame and the CTS frame are MAC frames generated in an MAC layer. A method in which the transmitter informs the receiver of a bandwidth (called a first bandwidth) over which the RTS frame is transmitted or a method in which the receiver informs the transmitter of a bandwidth (called a second bandwidth) over which the CTS frame is transmitted is problematic.

According to the proposed exemplary embodiment, the first and second bandwidths may be included in a physical layer convergence procedure (PLCP) header of a PLCP protocol data unit (PPDU) including a corresponding MAC frame. The PLCP header may include an indicator indicating that the bandwidth is dynamically changed during the RTS-CTS process.

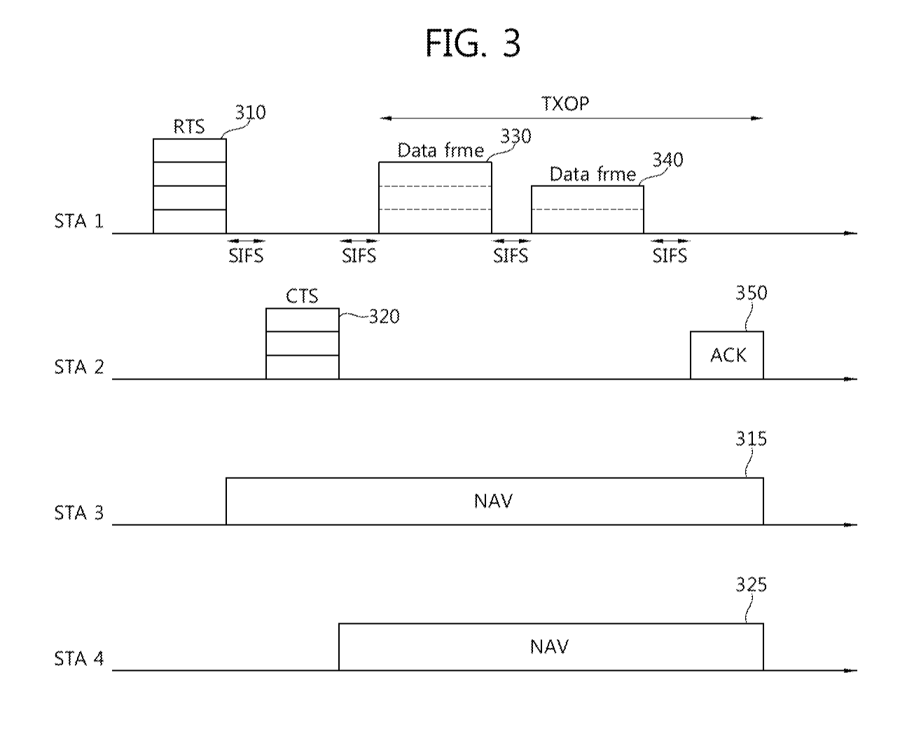

FIG. 3 is a flow chart illustrating a method for multiple frame transmission according to the exemplary embodiment of the present invention. The exemplary embodiment of FIG. 2 will be described in detail in a temporal sequence with reference to FIG. 3.

An STA1 transmits a RTS frame 310 and serves as a transmitter. An STA2 transmits a CTS frame 320 as a response to the RTS frame 310 and serves as a receiver.

The STA1 transmits the RTS frame 310 to the STA2 over four subchannels. Then, the STA2 transmits the CTS frame 320 to the STA1. Therefore, the STA1 obtains a TXOP. A bandwidth for the TXOP is equal to a bandwidth of the CTS frame 320. The bandwidth of the CTS frame 320 is equal to or less than a band width of the RTS frame 310.

An STA3 positioned in the vicinity of the STA1 listens to the RTS frame 310 and establishes a NAV 315. The STA3 establishes the NAV 315 based on a value obtained from a duration field of the RTS frame 310.

An STA4 positioned in the vicinity of the STA2 listens to the CTS frame 320 and establishes a NAV 325. The STA4 establishes the NAV 325 based on a value obtained from a duration field of the CTS frame 320.

The STA1 sequentially transmits first and second data frames 330 and 340 to the STA2 during the TXOP. A bandwidth of the first data frame 330 is equal to or less than a bandwidth of the CTS frame 320. A subsequent data frame has a bandwidth equal to or less than a bandwidth of a data frame that is last previously transmitted before the subsequent data frame. The present exemplary embodiment shows that the first data frame 330 has a bandwidth of 60 MHz and the second data frame 340 has a bandwidth of 40 MHz.

After the STA2 receives the data frames 330 and 340, it transmits an ACK frame 350 as a reception acknowledge to the data frames 330 and 340 to the STA1.

The RTS-CTS frame may be applied to MU-MIMO. The transmitter transmits the RTS frame to a plurality of receivers. A representative receiver of the plurality of receivers may transmit the CTS frame to the transmitter. The representative receiver may transmit the CTS frame within a maximum bandwidth capable of being commonly supported by the plurality of receivers.

Information on available subchannels or available bandwidths may be transmitted through a sounding frame. The sounding frame may be transmitted before or after a process of exchanging the RTS-CTS frames.

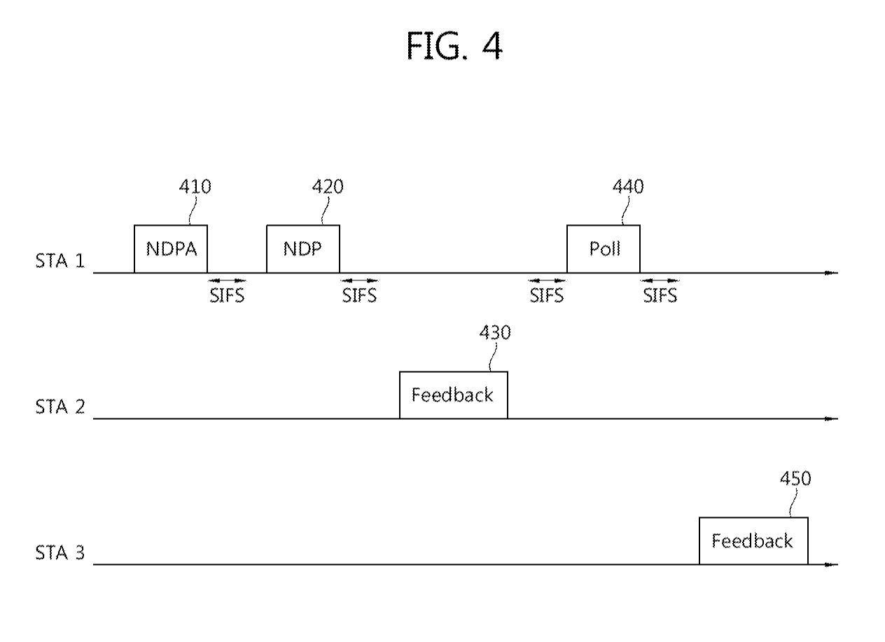

FIG. 4 is a flow chart illustrating a method for bandwidth information transmission in a sounding procedure.

A sounding process is a procedure for detecting a channel state for SU-MIMO or MU-MIMO transmission. An STA 1 becomes a beamformer that performs the MU-MIMO transmission, and an STA2 and an STA3 become beamformee that receives a beamformed data frame.

The STA 1 transmits a null data packet announcement (NDPA) frame 410. The NDPA frame 410 includes STA information on each beamformee. The STA information includes an identifier of a corresponding STA, a feedback type indicating SU or MU, and an index indicating the number of requested spatial streams. Here, it is assumed that the NDPA frame 410 sequentially includes first STA information for the STA2 and second STA information for STA3.

After the NDPA frame 410 is transmitted, the STA1 transmits a null data packet (NDP) frame 420. The NDP frame is used for the STA2 and STA3 to measure the channel state.

The STA2 corresponding to the first STA information among the STAs receiving the NDPA frame 410 transmits a feedback frame 430 to the STA1. The feed back frame 430 includes channel state information on the number of spatial streams, a channel bandwidth for which measurement is performed, a feedback type, and a beamforming feedback matrix. The feedback type is set to the same value as that of the feedback type of corresponding STA information.

The channel state information includes feedback information in the form of angles representing beamforming feedback matrices for use by a transmit beamformer to determine steering matrices. The feedback information contains the channel matrix elements indexed, first, by matrix angles in the order shown in a predefined table and, second, by data subcarrier index from lowest frequency to highest frequency. Further, the channel state information includes signal-to-noise (SNR) information for each space-time stream and an averaged SNR information for all space-time streams.

The STA1 transmits a poll frame 440 to the STA3. The poll frame 440 is a frame requesting the STA3 for feedback.

The STA3 transmits a feedback frame 450 to the STA1.

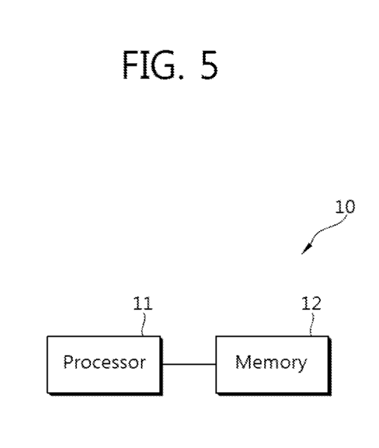

FIG. 5 is a block diagram illustrating a transmitter in which the exemplary embodiment of the present invention is implemented. The exemplary embodiments of FIGS. 2 to 4 may be implemented by the transmitter.

The transmitter 10 includes a processor 11 and a memory 12. The processor 11 implements a function of the transmitter, the beamformer, or the beamformee in the exemplary embodiments of FIGS. 2 and 4. The processor 11 may transmit a RTS frame and at least one data frame. The memory 12 stores parameters for an operation of the processor 11 therein.

The processor may include application-specific integrated circuit (ASIC), other chipset, logic circuit and/or data processing device. The memory may include read-only memory (ROM), random access memory (RAM), flash memory, memory card, storage medium and/or other storage device. The RF unit may include baseband circuitry to process radio frequency signals. When the embodiments are implemented in software, the techniques described herein can be implemented with modules (e.g., procedures, functions, and so on) that perform the functions described herein. The modules can be stored in memory and executed by processor. The memory can be implemented within the processor or external to the processor in which case those can be communicatively coupled to the processor via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for multiple frame transmission in a wireless communication system, the method comprising,
transmitting, by a transmitter, a request to send (RTS) frame to a receiver, the RTS frame having a first bandwidth;
receiving, by the transmitter, a clear to send (CTS) frame as a response of the RTS frame from the receiver, thereby establishing a transmission opportunity (TXOP) indicating an interval of time when the transmitter has the right to transmit at least one data frame, the CTS frame having a second bandwidth; and
transmitting, by the transmitter, a plurality of data frames sequentially to the receiver during the TXOP,
wherein a bandwidth of each data frame is equal to or less than the second bandwidth, and
wherein a bandwidth of a subsequent data frame is equal to or less than a bandwidth of a preceding data frame which is last previously transmitted before the subsequent data frame.

2. The method of claim 1, wherein the second bandwidth is equal to or less than the first bandwidth.

3. The method of claim 2, wherein the first bandwidth is one of 40 MHz, 80 MHz and 160 MHz and the second bandwidth is one of 20 MHz, 40 MHz, 80 MHz and 160 MHz.

4. The method of claim 3, wherein the RTS frame is duplicately transmitted over each 20 MHz of the first bandwidth.

5. The method of claim 4, wherein the CTS frame is duplicately received over each 20 MHz of the second bandwidth.

6. A transmitter of multiple frame transmission in a wireless communication system, comprising a processor configured to:
transmit a request to send (RTS) frame to a receiver, the RTS frame having a first bandwidth;
receive a clear to send (CTS) frame over a second bandwidth as a response of the RTS frame from the receiver, thereby establishing a transmission opportunity (TXOP) indicating an interval of time when the transmitter has the right to transmit at least one data frame, the CTS frame having a second bandwidth; and
transmit a plurality of data frames sequentially to the receiver during the TXOP,
wherein a bandwidth of each data frame is equal to or less than the second bandwidth, and
wherein a bandwidth of a subsequent data frame is equal to or less than a bandwidth of a preceding data frame which is last previously transmitted before the subsequent data frame.

7. The transmitter of claim 6, wherein the second bandwidth is equal to or less than the first bandwidth.

8. The transmitter of claim 7, wherein the first bandwidth is one of 40 MHz, 80 MHz and 160 MHz and the second bandwidth is one of 20 MHz, 40 MHz, 80 MHz and 160 MHz.

9. The transmitter of claim 8, wherein the RTS frame is duplicately transmitted over each 20 MHz of the first bandwidth.

10. The transmitter of claim 9, wherein the CTS frame is duplicately received over each 20 MHz of the second bandwidth.
